(19) United States
(12) Patent Application Publication
(10) Pub. No.: US 2025/0137889 A1
(43) Pub. Date: May 1, 2025

(54) APPARATUS COMPRISING AN INTERFACE FOR DETACHABLE COUPLING OF A DISSECTION TOOL

(71) Applicant: XYALL B.V., Eindhoven (NL)

(72) Inventors: Martijn VAN TUIJL, Helmond (NL); Reinhold WIMBERGER-FRIEDL, Eindhoven (NL)

(21) Appl. No.: 18/567,446

(22) PCT Filed: Jun. 9, 2022
(86) PCT No.: PCT/EP2022/065711

§ 371 Date: Dec. 6, 2023

(30) Foreign Application Priority Data
Jun. 11, 2021 (EP) 21178992.0

(51) Int. Cl. G01N 1/08

(52) U.S. Cl. CPC G01N 1/08

(57) ABSTRACT

Some embodiments relate to an Apparatus for automated dissection of biological material from a sample disposed on a planar substrate. The apparatus can include a tool interface for releasable attachment of a dissection tool that is connectable to the interface via a push fitting. The interface can include a mechanism for enabling the at least one push fitting to be disengaged, which mechanism includes one or more lever arms each pivotably connected to a housing of the interface via a horizontal pivot axis. The apparatus can detach a tool by lowering the interface relative to a surface that surrounds an opening until a first engagement surface of each lever arm makes contact with the aforementioned surrounding surface and causes a corresponding second engagement surface of each lever arm to act on an upper surface of the tool to exert a force that disengages the at least one push fitting.

### CROSS-REFERENCE TO RELATED APPLICATIONS

This application is a national phase filing under 35 C.F.R. § 371 of and claims priority to PCT Patent Application No. PCT/EP2022/065711, filed on Jun. 9, 2022, which claims the priority benefit under 35 U.S.C. § 119 of European Patent Application No. 21178992.0, filed on Jun. 11, 2021, the contents of each of which are hereby incorporated in their entireties by reference.

### FIELD OF THE INVENTION

The presently disclosed subject matter relates to an apparatus for automated dissection of biological material disposed on a planar substrate, such as a glass slide, and is more particularly directed to an interface of the apparatus and a method for automated attachment and detachment of a dissection tool.

### BACKGROUND ART

To perform a molecular analysis of a tumor, for the purposes of oncology diagnostics, a certain amount and concentration of tumor cells must or should be present in the sample to be analyzed. Tumor tissue is heterogenous and contains other tissue and cell types. Therefore, a region of interest (ROI) is typically defined as the sample to be dissected from a thin section of tissue disposed on a microscope slide. Manual methods of dissection are most common, in which a lab technician scrapes material from the ROI using e.g. a scalpel blade and transfers the scraped material into a collection tube.

An example of an automated device for extracting material from a biological sample via milling is disclosed in U.S. Pat. No. 10,876,933. The device includes a head assembly and a stage that can accommodate and collect samples from several tissue slides and enables automated filling and uploading of several milling tips into a plurality of corresponding sample collection vials. The stage includes a plurality of receptacles adapted to receive a corresponding number of spring-loaded milling tip holders, which are used for automatic loading of the milling tips by the head assembly. The stage further accommodates a fill station for filling the milling tips with a buffer solution. In an embodiment, the stage supports a tray into which receptacles are formed for receiving the spring-loaded milling tip holders and sample collection vials. When a milling tip is securely seated in the corresponding holder, a threaded section of the milling tip can be threaded to the head assembly and automatically moved to the fill station for filling with buffer solution. After dissection, the used milling tip can then be reloaded into a holder or discarded to avoid cross-contamination.

A further example of such an automated device having an interchangeable milling tip is known from U.S. Pat. No. 10,866,170.

In the field of liquid handling devices, in which a single pipette tip or an array of pipette tips is attached to a plunger mechanism for dispensing a metered amount of liquid into e.g. a microwell plate, automated methods of pick-up and detachment are generally applied. US 2019/0314808, for example, discloses a device with an array of attachments that extend through an ejector plate. The device is configured to pick up a corresponding array of disposable tips by pressing the attachments into an opening in the pipette tip. After use, the ejector plate is driven by a mechanical actuator and is moved downward to push off the attached tips.

DE 19917855 discloses a device in which a lever is activated in order to push off a single pipette. The device is equipped with an electromagnet that is energized in order to pull up one end of the lever arm.

There is still room for improvement in terms of defining an apparatus for automated dissection of biological material that allows a dissection tool to be attached and detached from a movable head in a straightforward automated manner.

### SUMMARY OF THE INVENTION

In a first aspect, the presently disclosed subject matter relates to an apparatus for automated dissection of biological material from a tissue sample disposed on e.g. a glass slide, which includes an interface for releasable attachment of a disposable dissection tool. The tool is attachable to the interface via at least one push fitting and is rotatable about a vertical rotation axis.

To permit disengagement of the tool, the interface is equipped with one or more lever arms, each pivotably connected to a housing of the interface about a horizontal pivot axis and arranged at a radially outer location relative to the at least one push fitting. Each lever arm has first and second engagement surfaces at first and second ends thereof, whereby the first engagement surface is generally located at a greater radial distance from the vertical rotation axis than the second engagement surface. The tool has an upper collar, which in attached condition possibly bears against an underside of the interface housing. According to the presently disclosed subject matter, the tool upper collar and the one or more lever arms are configured such that when the tool is in attached condition, the first engagement surface of each lever arm lies radially outside of the outer collar, and such that the second engagement surface will make contact with and exert a disengaging force on an upper surface of the tool collar when the first end of each lever arm is displaced in upward direction by a sufficient amount.

Furthermore, the apparatus is configured to detach the tool simply by lowering the interface relative to a surface that surrounds an opening of sufficient depth to receive a main body of the tool. The upward displacement of each lever arm is effected by contact between the surrounding surface and each lever first engagement surface. An apparatus in accordance with the presently disclosed subject matter therefore enables automated detachment in a straightforward manner, via the application of relatively low force.

In order to perform high-precision dissection, the tool is attached with precise alignment. The attachment between the tool and the interface therefore possibly includes one or more conical connections. The interface may include a number of conical pins that engage in corresponding conical recesses provided at an upper end of the tool. Alternatively, the tool may include a number of conical pins that engage in corresponding conical recesses in the housing.

The push fitting that provides a locking force between the tool and the interface may be achieved via an interference fit between the one or more conical connections. In other embodiments, the locking force is mainly provided via a snap-fit connection.

In an embodiment, the interface includes one central conical protrusion that extends from an underside of the interface housing and the tool includes a central conical recess that is surrounded by the upper collar. The tool may be provided with a number of snap-fit joints arranged at an entrance to the conical recess and the interface protrusion may be provided with an annular ridge that engages in the snap-fit joints when the protrusion is pushed into the recess.

As will be understood, the one or more lever arms on the interface are adapted to exert a force that is greater than the locking force between the tool and the interface.

To ensure sufficient lever force, the interface may be provided with at least two lever arms arranged with an even angular spacing relative to the vertical rotation axis. In an embodiment, the interface includes three lever arms.

Suitably, the pivot axis of each lever arm is located farther from the first end than the second end, to maximise the effective length of the lever. Furthermore, when each lever arm is in a rest position, the first engagement surface possibly lies in a first horizontal plane that is lower than a generally horizontal plane of the housing underside. In an embodiment, the first end of each lever arm includes a vertical extension and the housing underside includes a suitable opening through which it extends. When the tool is attached, the vertical extension and first engagement surface then lies below the upper surface of the tool collar.

The corresponding second engagement surface of each lever arm is located in a second horizontal plane, which possibly lies relatively higher than the first when the lever arm is in a non-activated position. The second engagement surface may lie in the same plane as the underside of the housing, or somewhat higher. To permit the second engagement surface of each lever arm to extend beneath the housing underside when the first end of the lever is activated, a further opening is provided, or a longitudinal slot may be provided in the underside that permits both ends of the relevant lever to protrude.

As mentioned above, activation of the levers is possible via a downward movement of the tool and the application of a relatively low force. The downward movement can also be used to pick up a tool.

The apparatus of the presently disclosed subject matter suitably includes an assembly of actuators that are used to move the tool from a tool docking and undocking station to a dissection station, where the slides including e.g. thin sections of paraffin-embedded tumour tissue are located, and to perform the X- and Y-translations and rotational movements needed to dissect material from an identified region of interest. To enable high-speed and high-precision dissection, it is advantageous to minimise the weight of the actuator assembly. The tool interface of the presently disclosed subject matter permits the use of a lightweight and compact actuator for performing the movements needed to dock and undock a dissection tool. Suitably, the interface is fixed connection with a rotary actuator that enables the interface and attached tool to be rotated about the vertical rotation axis and with a linear actuator that permits movement of the interface and tool in vertical direction. The rotary actuator and the linear actuator are also used during dissection to control an orientation of the blade and to bring the scraping blade into contact with the glass slide with a controlled downward force. A stack of linear actuators may be used, which are in connection with each other, including an x-stage, a y-stage for the translational motions during dissection and a z-stage for the vertical motions. In an embodiment, the rotary actuator is connected to the z-stage. The rotary actuator may include a stepper motor or a linear drive motor with a hollow axis for allowing a pneumatic connection with the interface and tool, such that suction may be applied during dissection. The z-stage may include a hinge bearing for position control, to ensure a constant and precise downward force during dissection. Alternatively, the z-stage may be equipped with a force feedback control to maintain the downward force at a desired level.

In a further development, the apparatus includes a tool carrier having a main recess that is shaped to receive a dissection tool as described above. The main recess is surrounded by an upper surface which contains a number of relatively higher portions and a number of relatively lower portions, at least equal to the number of lever arms of the tool interface. When the tool interface is in a first angular position, being a pick-up position, the position of the relatively lower portions coincides with the position of the first engagement surface of each lever arm. In one example, the relatively higher portions of the carrier surface are formed by essentially flat sections and the relatively lower portions are formed by indentations in alignment with each first engagement surface.

One way, the apparatus includes a tray containing a plurality of such tool carriers for receiving a plurality of dissection tools. In an embodiment, the apparatus includes a number of such trays arranged on moveable carriers for automated insertion and removal of the trays.

Consequently, a tool can be picked up by lowering the interface relative to a tool held in a tool carrier by an amount sufficient to engage the at least one push fitting, without engaging the first end of each lever arm.

After dissection, the tool may be disposed of in a separate receptacle with an opening of suitable diameter such that the first end each lever arm is activated when the tool is lowered into the opening and makes contact with the surrounding surface.

In an embodiment, the apparatus is configured to deposit a used tool back into the same carrier. To enable this, the actuator rotates the interface to a second angular position, being a position in which the first end of each lever arm is in alignment with the aforementioned relatively higher portions of the carrier surface, such that lowering the tool into the shaped recess of the carrier brings the first end of each lever arm into contact therewith, causing it to pivot and displace the second end, which releases the tool from the interface.

Thus, docking and undocking of a dissection tool can be performed in an automated manner that may require the application of minimal force.

In an embodiment, an apparatus for dissection according to the presently disclosed subject matter is configured for use in conjunction with suction. The tool then includes an internal passageway that extends through the tool in vertical direction and has an orifice at one end where a scraping blade is arranged. The scraping blade is possibly made of a metal having a high yield stress. An air-permeable filter element is arranged in the internal passageway and a section of the internal passageway between the filter element and the orifice serves as a suction nozzle.

The interface housing is similarly provided with an internal passageway that extends in vertical direction through the interface and which connects with the tool internal passage in an airtight manner when the tool is in attached condition. In the embodiment where the interface includes a central conical protrusion and the tool includes a central conical recess, the housing internal passageway extends through the conical protrusion and engagement with the tool conical recess provides the airtight connection. In other embodiments, a seal may be provided at the connection between the interface internal passageway and the tool internal passageway.

The internal passageway of the interface is connectable via suitable tubing and optional valves to a vacuum generator, such that during dissection, an underpressure is generated an attachment end of the dissection tool. This creates an uplifting airstream at the tool orifice, which suctions material dissected by the scraping blade into the nozzle, where it is held at an underside of the filter element.

The apparatus may suitably include a further station where collection tubes are held. After use, the dissected material can be ejected straight into a collection tube, by applying a pressure pulse, thereby minimising the risk of contamination. The tool is then disposed of into a waste receptacle or is returned to the docking/undocking station where it is deposited in a tool carrier and a fresh tool is picked up in the manner described above.

In a further aspect, the presently disclosed subject matter relates to an interface for releasable attachment of a dissection tool, the tool interface including:
an internal passageway that extends through the interface in vertical direction, the passageway having a vertical centreline, whereby one end of the passageway including a fitting for airtight connection with a vacuum generator and an opposite end of the internal passageway enabling an airtight connection with an internal passageway of the tool; and
structure enabling mechanical connection of the tool via at least one push fitting.
In accordance with the presently disclosed subject matter, the interface further includes one or more lever arms each pivotably connected to a housing of the interface via a horizontal pivot axis (135), whereby:
   each lever arm is arranged at a radially outer location relative to structure enabling a push fitting; and
   each lever arm has first and second ends with respective first and second engagement surfaces, whereby the first engagement surface is arranged at a greater radial distance from the vertical centreline than the second engagement surface.

In an embodiment, the first engagement surface of each lever arm generally lies in a first horizonal plane, and the corresponding second engagement surface is generally arranged in a second horizonal plane which lies upward of the first horizonal plane.

In an advantageous further development, the structure enabling a push fitting and the structure enabling an airtight connection with the tool include a hollow, central conical protrusion that extends from an underside of the housing. As described above, an outer surface of the central conical protrusion may include an annular ridge, at a location between the underside of the housing and a conically shaped end portion of the protrusion. The annular ridge forms part of the push fitting and is adapted for snap-fit engagement with the tool.

In a still further aspect, the presently disclosed subject matter relates to a method of attaching and a method of detaching a dissection tool from an apparatus including a tool interface as defined above, whereby the tool is attached to the interface via at least one push fitting. The method of attachment includes a step of:
vertical movement of the interface relative to a tool carrier having a recess which holds a body of the dissection tool and is surrounded by an upper surface having a number of relatively higher portions and relatively lower portions, at least equal to the number of lever arms of the tool interface, whereby
   the position of the relatively lower portions coincides with the position of the first engagement surface of each lever arm when the interface is in a first angular position;
   the vertical movement is sufficient to engage the at least one push fitting; and
   the depth of the relatively lower portions is such that engagement of the push fitting occurs without being affected by contact between the first engagement surface of each lever arm and the tool carrier.

The method of detachment includes a step of:
lowering the interface relative to a surface that surrounds an opening of sufficient depth to receive a main body of the tool, whereby the opening is sized such that displacement of each lever arm is effected by contact between the surrounding surface and the first engagement surface of each lever arm.

In an embodiment, the method of detachment includes returning a tool to the same tool carrier and includes a further step of:
rotating the tool interface and attached tool about the vertical axis, free from load, to a second angular position in which the first engagement surface of each lever arm is in alignment with the relatively higher portions of the carrier surface; and.
the step of lowering includes vertical movement of the interface relative to the tool carrier, so as to bring the first engagement surface of each lever arm into contact with the relatively higher potions of the tool carrier upper surface and cause each lever arm to pivot, such that the corresponding second engagement surface is displaced against an upper surface of the tool and disengages the at least one push fitting.

It will be appreciated by those skilled in the art that two or more of the above-mentioned embodiments, implementations, and/or aspects of the presently disclosed subject matter may be combined in any way deemed useful.

### BRIEF DESCRIPTION OF THE DRAWINGS

The presently disclosed subject matter will now be further elucidated with reference to the embodiments described hereinafter. In the drawings,

FIG. 1a schematically shows a cut view of a dissection tool attached to a tool interface of an apparatus according to an embodiment of the presently disclosed subject matter;

FIG. 1b is a perspective view of an underside of the tool interface depicted in FIG. 1a;

FIG. 1c is a cross-sectional view of an example of a dissection tool;

FIG. 2 shows a front view of the dissection tool from FIG. 1c attached to the tool interface, with part of a housing of the interface cut away to reveal a lever arm of the interface;

FIG. 3a is a perspective view of part of a tray including a number of tool carriers which are shaped to hold the dissection tool shown in FIG. 1c and FIG. 2;.

FIG. 3b shows a top view of two adjacent tool carriers;

FIG. 4 shows a partially cut side view of the tool interface in a first position where it has been lowered into a tool carrier for picking up a dissection tool;

FIG. 5a shows a partially cut front view of the interface housing, with attached tool, in a second position where the tool has been lowered into the tool carrier such that the depicted lever arm makes contact with an upper surface of the tool carrier;

FIG. 5b shows the arrangement depicted in FIG. 5a when the interface has been lowered by a further amount, so as to displace the depicted lever arm.

It should be noted that items which have the same reference numbers in different figures, have the same structural features and the same functions. Where the function and/or structure of such an item has been explained, there is no necessity for repeated explanation thereof in the detailed description.

### DETAILED DESCRIPTION OF EMBODIMENTS

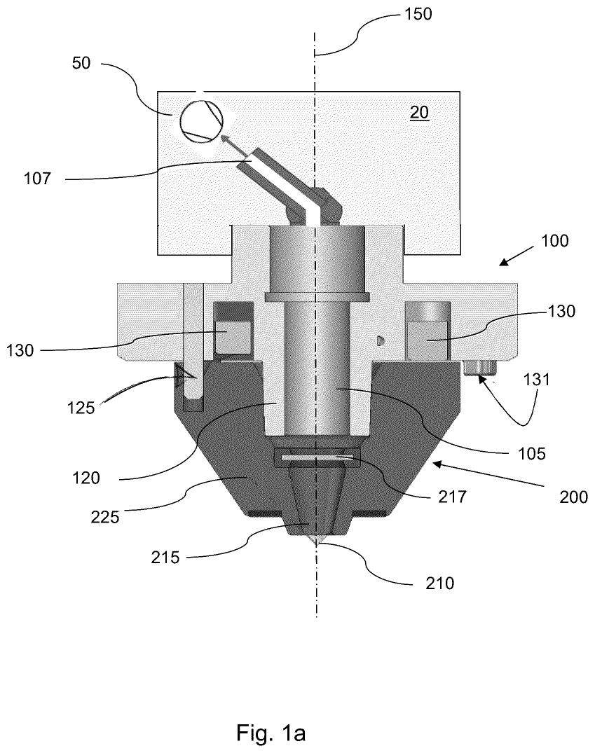

FIG. 1a schematically shows a cut view of a dissection tool 200 attached to a tool interface 100 which form part of a dissection apparatus according to an embodiment of the presently disclosed subject matter. A first end of the dissection tool includes a blade 210 for scraping off biological material from a tissue sample disposed on a slide. The apparatus further includes an actuator 20 to which the tool interface 100 is fixed, which forms part of an assembly of actuators which are suitably controlled and moved in order to bring the scraping blade 210 into contact with a slide surface and detach biological material from an identified region of interest ROI of a tissue sample. The actuator 20 is movable in vertical direction and permits rotation about a vertical axis 150 and is used both during dissection and for automated attachment and detachment of the dissection tool, which will be explained in detail later.

The depicted dissection tool is adapted to work in combination with suction. The tool thus includes a nozzle 215 having an orifice where the blade 210 is arranged and an internal passageway that extends through the tool and connects with an internal passageway 105 through the tool interface 100. The internal passageways are connectable to a vacuum generator 50, via suitable tubing 107, so that during use of the tool, biological material dissected by the blade 210 is suctioned into the nozzle 215, where it is caught at the underside of an air-permeable filter element 217 arranged to span the tool internal passageway. The tool 200 is designed for single use.

At the end of the dissection process, the tool 200 must or should be detached from the interface 100. To enable high-resolution and high-precision dissection at relatively high speed the actuator 20 is lightweight and compact. To facilitate efficient automated processing of multiple tissue samples, it is advantageous if the tool 200 can be detached from the interface 100 and a new tool attached in an automated manner that does not add to the complexity and the weight of the assembly of actuators. The attachment interface 100 of the presently disclosed subject matter is thus designed to enable precise, stable and airtight attachment of the tool 200, followed by detachment, in a straightforward, automated manner that may require the actuator 20 to exert minimal force.

This will be explained also with reference to FIG. 1b, which shows a perspective view of the underside of the inventive tool interface 100 and FIG. 1c, which shows a cross-sectional view of the dissection tool 200.

The interface 100 includes a housing 110 which has a generally planar underside 115 from which a central conical protrusion 120 extends. The protrusion 120 is hollow and forms part of the internal passageway 105 explained above. A body 225 of the tool includes a corresponding conical recess 220. The conical protrusion 120 and the conical recess 220 have a common centre axis, which coincides with the vertical rotation axis 150 (refer FIG. 1a). This provides a self-aligning, airtight connection between the tool and the interface. Additionally, the interface may include an alignment pin 125 that fits into a corresponding hole that extends into the tool body 225. The geometry of the interface and the tool thus enables the tool to be attached with a precise location, which may be necessary to enable the blade 210 to perform high-precision dissection.

In some embodiments, the locking force between the tool and the interface is realized via a press fit between the conical protrusion 120 and the conical recess 220. Alternatively, the locking force may be provided via a snap-fit connection. The conical protrusion 220 may include an annular ridge (not shown) which engages with snap-fit joints on the tool.

As shown in FIG. 1c, the tool 200 includes an upper collar 230 having an essentially flat upper surface 232, which surrounds an entrance to the conical recess 220. A number of snap-fit joints 235—three in the depicted embodiment—are provided at the entrance to the conical recess, which engage with the annular ridge on the conical protrusion 120 when the interface protrusion is pushed into the tool recess. In the depicted example, the snap-fit joints are cantilever arms that extend within a corresponding indentation 237 in the tool body 225 at the entrance to the conical recess 220. A gap between each arm 235 and a radially outer wall of the indentation 237 permits flexure of the arm needed for engagement and disengagement with the annular ridge on the interface conical protrusion 220. Suitably, the snap fit joints 235 are arranged at even angular intervals around the entrance to the conical recess 220 and are adapted to provide a stable locking force that is sufficiently large to enable precise dissection using the tool, yet small enough to permit relatively low-force disengagement.

To enable detachment of the tool, the interface is provided with at least one lever arm that is pivotably connected to the interface 100 about a horizontal pivot axis and is moveable within the interface housing 110. In an embodiment, the interface includes three lever arms 130 which are arranged within the housing, at a radially outer location relative to the conical protrusion 120. A first end of each lever arm has a first engagement surface 131 that extends beyond the generally planar underside 115 of the housing 110. A second end of each lever arm has a second engagement surface (not visible in FIG. 1b) which can extend beyond the housing underside 115 when the lever arm is pivoted. As shown, the housing underside may include slots 117 that permit protrusion of the first and second engagement surface of each lever arm beyond the housing underside.

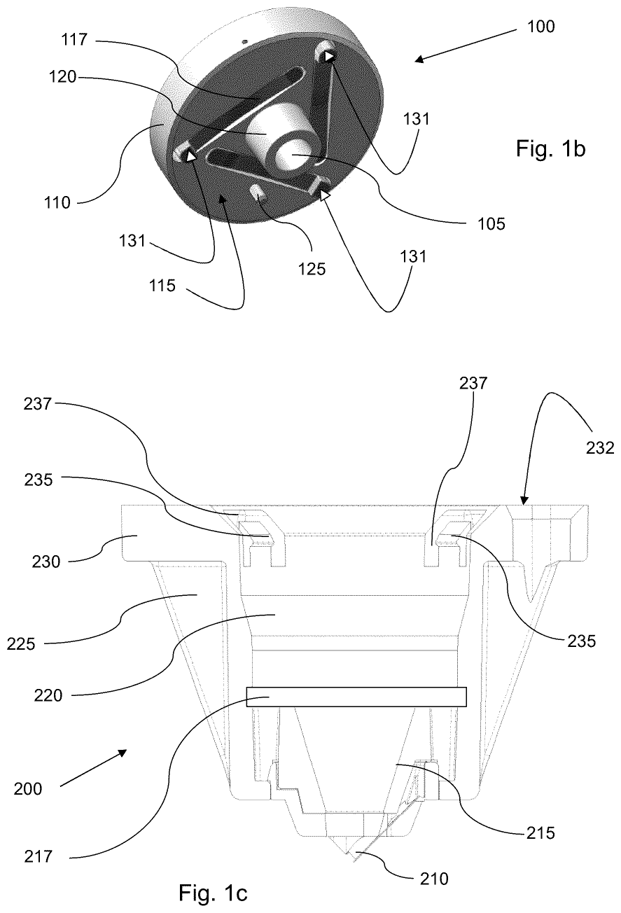

The process of tool detachment will be explained further with reference to FIG. 2, which shows a side view of the tool 200 attached to the interface 100, whereby part of the housing 110 is cut away to show one of the three lever arms 130. The lever arm is pivotable about pivot axis 135, which axis is located closer to the second end of the lever arm than the first end. Furthermore, the first end of the lever arm has a vertical extension 133, which is generally located at a radial distance x, relative to the centre axis 150 of the interface conical protrusion, whereby x is larger than an outer radius of the tool upper collar 230. The vertical extension 133 thus lies radially outside of the tool upper collar 230 such the first engagement surface 131 makes no contact with the tool. Suitably, the vertical extension 133 is sufficiently long to extend beyond an underside of the tool collar 230.

The second end of the pivot arm is generally located at a shorter radial distance y relative to the centre axis 150 than the first end of the lever arm. The distance y is such that when the tool is in attached condition, the second engagement surface 132 of the lever arm 130 lies above the upper surface 232 of the upper collar 230. The second engagement surface may be in contact with the collar upper surface or there may be a small gap. Displacement of the first engagement surface 131 of the lever arm 130 in an upward direction brings the second engagement surface 132 into contact with the collar upper surface 232 and exerts a force on the tool. Suitably the lever force exerted by the three lever arms is sufficient to overcome the locking force between the tool and the interface. In the embodiment where the tool is secured to the interface via snap fit joints, the combined lever force pushes the tool out of the engaged locking position.

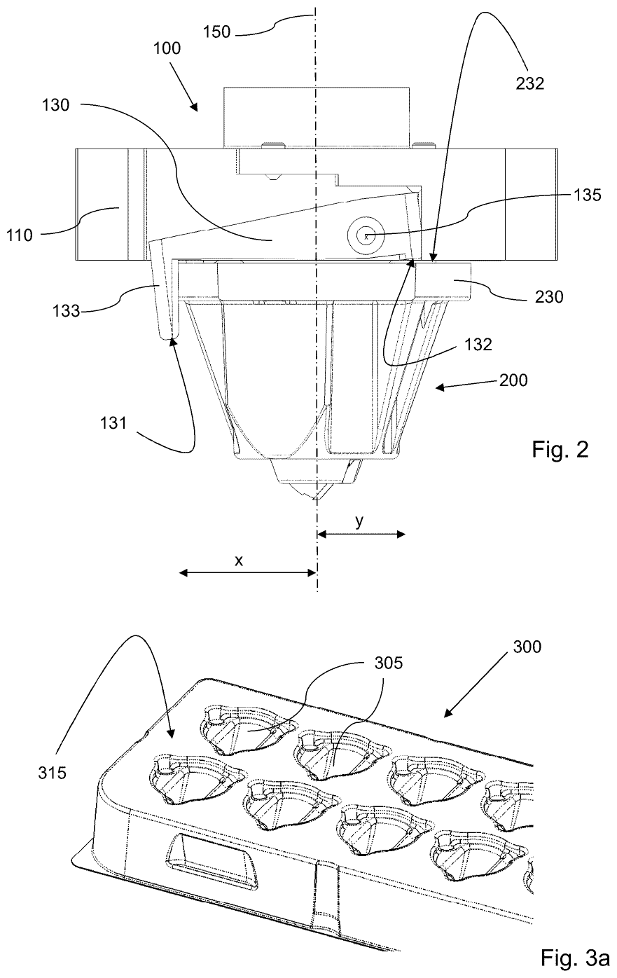

In an embodiment, the tool is deposited into a tool carrier tray 300, an example of which is shown in FIG. 3a. The tray includes a number of tool carriers each of which includes a recess 305 that is shaped to receive a tool body. One way, a tool is picked up from a tool carrier and replaced in the same carrier after use.

FIG. 3b shows a top view of two adjacent tool carriers 310, 320 in the carrier tray 300. Each tool carrier includes an identically shaped main recess 305 for accommodating a tool. In the depicted example, each carrier is shaped such that when a tool is held therein, the upper surface 232 of the tool upper collar does not protrude beyond an upper surface 315 of the tray. Each carrier further includes three indentations 311, 312, 313 relative to the tray upper surface 315, which are located radially outwards of the main recess 305 and which are adapted to the receive the first engagement surface 131 of each lever arm 130 of the tool interface 100. Let us assume that the interface will pick up a tool arranged in the first carrier 310.

The actuator lowers the conical protrusion of the interface into the first carrier 310, when the interface 100 is in a first angular position, being a pickup position in which the first engagement surface 131 of each lever arm is in alignment with the corresponding indentations 311, 312, 313 in the carrier.

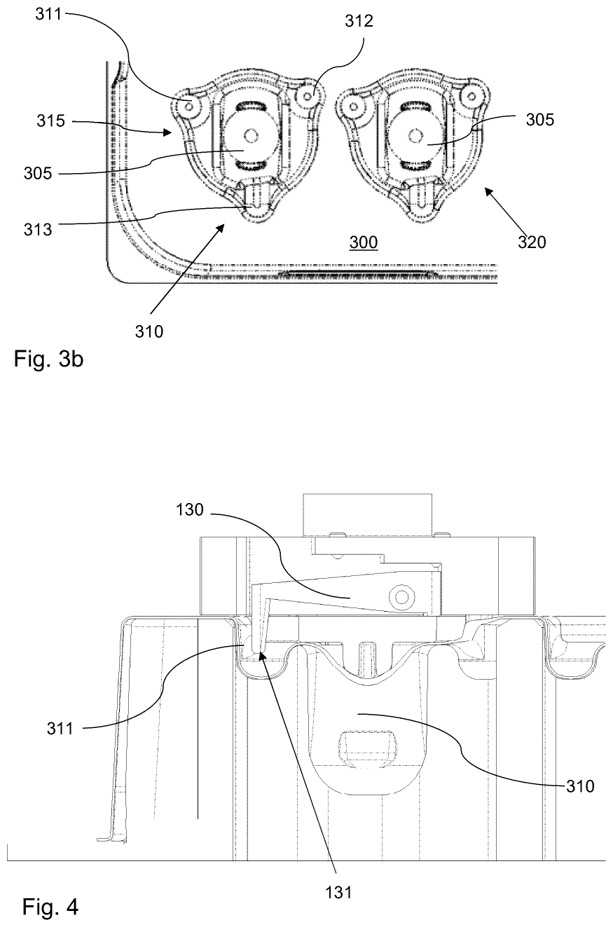

FIG. 4 shows the tool interface 100 after it has been lowered into the first carrier 310 for picking up a tool. The conical protrusion of the tool interface 100 can be lowered into the first carrier 310 without engagement of the lever arm 130 because the first engagement surface 131 is in alignment with the first indentation 311 of the first carrier 310. Similarly, the first engagement surface of the second and third lever arms are in alignment with the second and third indentations 312, 313 respectively. As will be understood, the indentations have a sufficient depth to enable the conical protrusion 120 to be lowered until the annular ridge engages with the snap joints 235 at the entrance to the tool conical recess 220. Downward movement of the actuator and the application of a relatively small force is thus sufficient to mechanically connect the tool to the interface. Possibly, the tray of carriers is able to flex somewhat, such that the tool can be displaced in the X-Y plane while being held in the recess 305, to enhance alignment.

After dissection using the tool, it may be deposited back into the first carrier 310. The actuator rotates the interface 100 about the vertical axis 150 to a second angular position, in which the first engagement surface of each lever arm is out of alignment with the indentations and will make contact with the upper surface 315 of the tray. In the depicted embodiment, the second angular position is a half turn from the first angular position, given that the tool body, and shaped recess 305, has two degrees of rotational symmetry. Other configurations are of course possible.

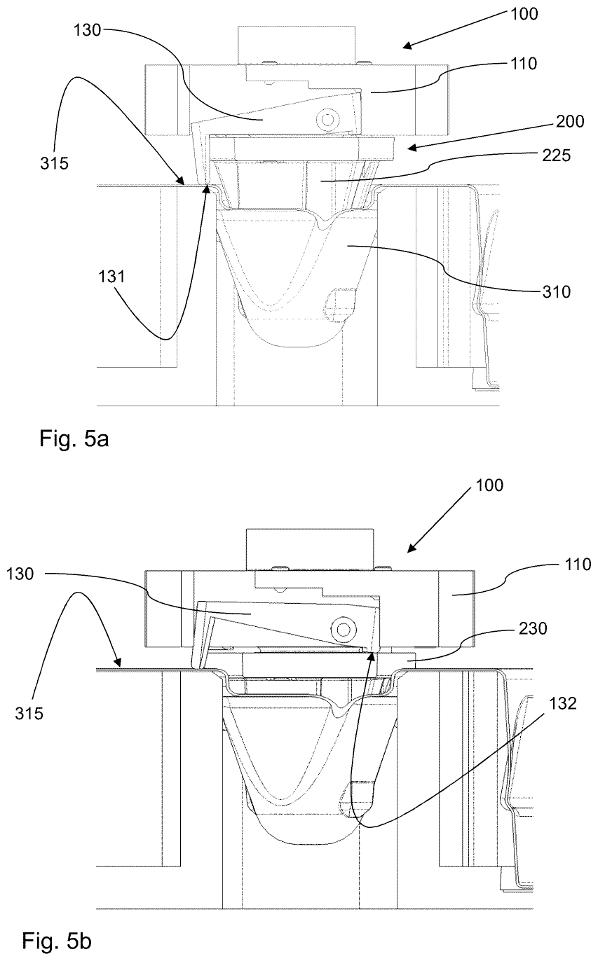

The detachment process is evident from FIGS. 5a and 5b, which show the tool being lowered into the first tool carrier 310 of the tool carrier tray 300. After rotation to the second angular position, the actuator moves the interface 100 and tool 200 downward towards the tray, which is now positioned relative to the tool such that the tool body 225 is inserted into the shaped recess of the tool carrier 310 and the first engagement surface 131 of the lever arm 130 now makes contact with the tray upper surface 315, as shown in FIG. 5a. Further downward movement causes the first end of the lever arm to be displaced upwards within the interface housing 110 as shown in FIG. 5b and the second engagement surface 132 of the lever arm is displaced to exert a releasing force on the tool collar 230, which disengages the snap-fit connection as explained above. When the tool has been released, the actuator raises the interface 100 until the conical protrusion 120 is above the tray and can be moved to pick up a new tool that is arranged in an adjacent tool carrier of the carrier tray.

Thus, the actions desired in this embodiment to perform automated tool pickup and depositing are rotation about a vertical axis, free from load, and downward movement involving the application of low force. This can be achieved using a compact and lightweight actuator.

Examples, embodiments or optional features, whether indicated as non-limiting or not, are not to be understood as limiting the presently disclosed subject matter as claimed. It should be noted that the above-mentioned embodiments illustrate rather than limit the presently disclosed subject matter, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The presently disclosed subject matter may be implemented by hardware including several distinct elements, and by a suitably programmed computer. In the device claim enumerating several of these may be embodied by one and the same item of hardware. The mere fact that certain measures are recited in mutually different dependent claims does not indicate that a combination of these measures cannot be used to advantage.

### Reference Numerals

20 actuator
50 vacuum generator
100 tool interface
105 internal passageway through tool interface
107 tubing for connecting internal passageway to the vacuum generator
110 interface housing
115 planar underside of interface housing
117 longitudinal slot in interface housing
120 central conical protrusion of interface
125 alignment pin
130 lever arm
131 first engagement surface at first end of lever arm
132 second engagement surface at second end of lever arm
133 vertical extension at first end of lever arm
135 pivot axis of lever arm
150 centre axis of conical protrusion (and vertical rotation axis of actuator)
X radial distance of first engagement surface from centre axis of conical protrusion
y radial distance of second engagement surface from the centre axis
200 dissection tool
210 scraping blade at first end of dissection tool
215 suction nozzle of dissection tool
217 air-permeable filter element
220 conical recess of dissection tool
225 tool body
230 upper collar at second end of the tool
232 upper surface of the tool upper collar
235 snap-fit joint
237 indentation in tool body from which snap-fit joint extends
300 tool carrier tray
305 shaped recess of tool carrier
310 first tool carrier
311, 312, 312 1^{st}, 2^{nd} and 3^{rd} indentations of first tool carrier
315 upper surface of tool carrier tray
320 second tool carrier

1. An Apparatus for dissecting biological material from a sample disposed on a planar substrate, comprising a tool interface for releasable attachment of a dissection tool that is connectable to the interface via at least one push fitting and is rotatable about a vertical rotation axis wherein the interface further comprises one or more lever arms, each pivotably connected to a housing of the interface via a horizontal pivot axis whereby:
each lever arm is arranged at a radially outer location relative to the at least one push fitting and has first and second ends with respective first and second engagement surfaces, the first engagement surface being arranged at a greater radial distance from the vertical axis than the second engagement surface;
the tool has an upper collar which is dimensioned such that when the tool is attached to the interface, the first engagement surface of each lever arm lies outside of an outer dimension of the upper collar and makes no contact therewith, and is further dimensioned such that the second engagement surface of each lever arm will make contact with the an upper surface of the collar when the first end of the lever am is displaced in upward direction, causing the second engagement surface to exert a force on the collar that disengages the at least one push fitting; and
the apparatus is configured to detach the tool by lowering the interface relative to a surface that surrounds an opening of sufficient depth to receive a main body of the tool, such that displacement of each lever arm is effected by contact between said surrounding surface and each first engagement surface.

2. The Apparatus according to claim 1, wherein the at least one push fitting is at least partly formed by a snap-fit connection between the interface and the tool.

3. The Apparatus according to claim 1, wherein:
the interface comprises one or more conical protrusions that extend from an underside of the housing;
the tool comprises one or more conical recesses that are shaped to receive the one or more conical protrusions, and
the at least one push fitting is at least partly formed by the one more conical protrusions engaging in the corresponding conical recesses.

4. The Apparatus according to claim 3, wherein the one or more conical protrusions comprise an annular ridge and an entrance to the one or more tool conical recesses is provided with one or more snap-fit joints which engage with the annular ridge when an end section of the conical protrusion is pushed into the corresponding conical recess.

5. The Apparatus according to claim 3, wherein the interface comprises a central conical protrusion that is adapted to engage in a central conical recess of the tool.

6. This Apparatus according to claim 1, wherein:
the interface comprises an internal passageway that extends through the interface in vertical direction and is provided with a fitting for enabling an airtight connection with a vacuum generator,
the tool comprises an internal passageway that extends through the tool in vertical direction, and
when the tool is in attached condition, said internal passageways of the tool and the interface are connected in an airtight manner.

7. The Apparatus according to claim 1, wherein:
the interface comprises two or more lever arms arranged with an even angular spacing around the vertical axis.

8. The Apparatus according to claim 1, wherein in a rest position, the first engagement surface of each lever arm lies in a first horizonal plane, and the corresponding second engagement surface lies in a second horizonal plane which is higher than the first horizonal plane.

9. The Apparatus according to claim 1, further comprising an actuator in fixed connection with the interface, wherein the actuator is moveable in vertical direction and is rotatable between a first angular position and a second angular position about the vertical rotation axis, and wherein:
the apparatus further comprises a tool carrie having a main recess that is shaped to accommodate a body of the dissection tool and an upper surface surrounding the main recess, whereby the carrier upper surface includes a number of relatively higher portions and relatively lower portions at least equal to the number of lever arms of the tool interface;
the position of the relatively lower portions coincides with the position of the first engagement surface of each lever arm when the interface is in the first angular position; and
the apparatus is configured to attach a dissection tool arranged in the tool carrier when the interface is in the first angular position by moving the interface downwards relative to the tool carrier until the at least one push fitting engages, whereby a depth of the relatively lower portions is such that this engagement occurs without being affected by contact between the first engagement surface of each lever arm and the tool carriers.

10. The Apparatus according to claim 9, comprising a tray in which a plurality of tool carriers are incorporated for holding a plurality of dissection tools.

11. The Apparatus according to claim 9, wherein after use of a tool, the apparatus is further configured to return the tool to the tool carrier and detach the tool from the interface by:
rotating the interface to the second angular position, being a position in which the first engagement of surface of each lever arm is in alignment with the relatively higher portions of the carrier upper surface, and
lowering the tool into the tool carrier by an amount sufficient to bring the first engagement surface of each lever arm into contact with the relatively higher portions of the carrier upper surface and cause each arm to pivot, such that displacement of the second engagement surface against the tool collar surface exerts a force sufficient to disengage the at least one push fitting.

12. A method of attaching a dissection tool to a tool interface on a dissection apparatus comprising a tool carrier as defined in claim 9, the tool being attachable to the interface via at least one push fitting, the method comprising steps of:
arranging the tool in the tool carrier;
rotating the interface to a first angular position in which the position of the relatively lower portions of the tool carrier coincides with the position of the first engagement surface of each lever arm; and
lowering the interface relative to the tool carrier by an amount sufficient to engage the at least one pushing fitting.

13. The Method of detaching a dissection tool from a tool interface on a dissection apparatus as defined in claim 1, the tool being attached to the interface via at least one push fitting, the method comprising a step of:
lowering the interface relative to a receptacle having an opening of sufficient depth to accommodate a main body of the tool until the first engagement surface (of each lever arm makes contact with a surface that surrounds the opening and causes each lever arm to pivot, such that the corresponding second engagement surface is displaced against an upper surface of the tool and disengages the at least one push fitting.

14. The Method according to claim 13, wherein the receptacle is a tool carrier as defined in claim 9, and wherein prior to the step of lowering, the method further comprises:
rotating the tool interface and attached tool about the vertical axis, free from load, to a second angular position in which the first engagement surface of each lever arm is in alignment with the relatively higher portions of the carrier upper surface.
